(19) United States
(12) Patent Application Publication
(10) Pub. No.: US 2024/0338522 A1
(43) Pub. Date: Oct. 10, 2024

(54) GRADIENT CONTROL DEVICE AND GRADIENT CONTROL METHOD OF LANGUAGE MODEL

(71) Applicants: Hyundai Motor Company, Seoul (KR); Kia Corporation, Seoul (KR); Seoul National University R&DB Foundation, Seoul (KR)

(72) Inventors: Woojong Ryu, Seoul (KR); Seongmin Lee, Incheon (KR); Sungroh Yoon, Seoul (KR); Sangwon Yu, Seoul (KR)

(21) Appl. No.: 18/587,008

(22) Filed: Feb. 26, 2024

(30) Foreign Application Priority Data
Apr. 7, 2023 (KR) 10-2023-0045812

(51) Int. Cl. G06F 40/284

(52) U.S. Cl. CPC G06F 40/284

(57) ABSTRACT

Provided are a gradient control device and a gradient control method of a language model. The gradient control device of a language model may include: one or more processors, and memory storing instructions. The instructions, when executed by the one or more processors, may cause the gradient control device to calculate a number of occurrences of each token, of a plurality of tokens, in batch data at each training step of a plurality of training steps ranging from a current training step to a set previous training step; group rare tokens based on a comparison of the calculated number of occurrences of each token, of the plurality of tokens, with a threshold value; calculate a gate tensor on embedding vectors of the grouped rare tokens; and scale a gradient part that pushes the embedding vectors of the grouped rare tokens away from feature vectors having relatively non-rare and feature vectors having relatively rare target tokens, among gradients of a loss function for the embedding vectors of the grouped rare tokens in a training step.

### CROSS-REFERENCE TO RELATED APPLICATION

This application is based on and claims priority to Korean Patent Application No. 10-2023-0045812, filed on Apr. 7, 2023 in the Korean Intellectual Property Office, the disclosure of which is incorporated herein by reference.

### TECHNICAL FIELD

Embodiments of the disclosure relate to a gradient control device and a gradient control method of a language model.

### BACKGROUND

Neural language models have been developed in a variety of architectures. The language models take as input an embedding vector of a token to compute contextualized features.

The language models also project features onto categorical distribution of tokens in an output softmax layer having an embedding vector of a token as a weight.

Recent research has shown that a distribution of embedding vectors of tokens trained in a language model can degenerate into a narrow cone-shaped anisotropic distribution. Such a phenomenon is called a representation degeneration problem and it can increase overall similarity between the embedding vectors of tokens.

The phenomenon of the representation degeneration problem may negatively affect the performance of language models and reduce the expressiveness of the token's embedding vector, thus preventing the language models from effectively learning the semantic relationships between the tokens and from generating high quality text.

At least in some implementations, a method of post-processing or applying regularization-techniques to embedding vectors of all tokens has been used to overcome the phenomenon caused by the above-described representation degeneration problem.

However, how the embedding vectors of tokens are degenerated during learning is still unclear, and the above-described existing methods are typically applied to all embedding vectors of tokens, leading to over-regularization of the embedding vectors of tokens where semantic relationships are well trained.

### SUMMARY

An aspect of the disclosure provides a gradient control device and a gradient control method of a language model that may prevent an overall increase in similarity between embedding vectors of tokens, enabling a language model to learn a semantic relationship between tokens and generate high quality text.

Additional aspects of the disclosure will be set forth in part in the description which follows and, in part, will be obvious from the description, or may be learned by practice of the disclosure.

According to one or more example embodiments, a gradient control device of a language model may include: one or more processors; and memory storing instructions that, when executed by the one or more processors, cause the gradient control device to: calculate a number of occurrences of each token, of a plurality of tokens, in batch data at each training step of a plurality of training steps ranging from a current training step to a set previous training step; group rare tokens based on a comparison of the calculated number of occurrences of each token, of the plurality of tokens, with a threshold value; calculate a gate tensor on embedding vectors of the grouped rare tokens; and scale a gradient part that pushes the embedding vectors of the grouped rare tokens away from feature vectors having relatively non-rare and feature vectors having relatively rare target tokens, among gradients of a loss function for the embedding vectors of the grouped rare tokens in a training step.

The memory may further store the calculated number of occurrences of each token of the plurality of tokens.

The instructions, when executed by the one or more processors, may further cause the gradient control device to: calculate an average number of occurrences of each token of the plurality of tokens by summing all numbers, stored in the memory, of occurrences of each token of the plurality of tokens. The instructions, when executed by the one or more processors, may cause the gradient control device to group the rare tokens by determining one or more tokens, having an average number of occurrences less than the threshold value, to be the rare tokens.

The instructions, when executed by the one or more processors, may further cause the gradient control device to group the rare tokens by grouping first rare tokens and second rare tokens according to degrees of rarity.

The instructions, when executed by the one or more processors, may further cause the gradient control device to: calculate, using a first gate tensor application, a first gate tensor on a first gradient part, wherein the first gradient part is configured to push the embedding vectors of the grouped rare tokens away from the feature vectors having the non-rare target tokens when applied to training, among the gradients of the loss function; and control a degree of the pushing.

The instructions, when executed by the one or more processors, may further cause the gradient control device to: reduce, using the first gate tensor application, a scale of the first gradient part according to a reference value by calculating the first gate tensor on the first gradient part; and reduce the degree of the pushing.

The instructions, when executed by the one or more processors, may further cause the gradient control device to: calculate, using a second gate tensor application, a second gate tensor on a second gradient part, the second gradient part being configured to push the embedding vectors of the second rare tokens away from feature vectors having the rare target tokens, with a smaller number of occurrences than the non-rare target tokens, when applied to training; and control a degree of the pushing.

The second gate tensor application may be configured to keep a scale of the second gradient part from dropping below a reference value by calculating the second gate tensor on the second gradient part, and configured to increase the degree of the pushing relative to an original degree before the scale of the second gradient part is reduced.

According to one or more example embodiments of the disclosure, a method of controlling a gradient of a language model may include: calculating a number of occurrences of each token, of a plurality of tokens, in batch data at each training step of a plurality of training steps ranging from a current training step to a set previous training step; grouping rare tokens based on a comparison of the calculated number of occurrences of each token, of the plurality of tokens, with a threshold value; calculating a gate tensor on embedding vectors of the grouped rare tokens; and scaling a gradient part that pushes the embedding vectors of the grouped rare tokens away from feature vectors having relatively non-rare and feature vectors having relatively rare target tokens, among gradients of a loss function for the embedding vectors of the grouped rare tokens in a training step.

Grouping the rare tokens may include storing, in a memory, the calculated number of occurrences of each token of the plurality of tokens.

Grouping the rare tokens may include: calculating an average number of occurrences of each token of the plurality of tokens by summing all numbers, stored in the memory, of occurrences of each token of the plurality of tokens, and determining one or more tokens, having an average number of occurrences less than the threshold value, to be the rare tokens.

Grouping the rare tokens comprises grouping the rare tokens into a plurality of groups, and grouping first rare tokens and second rare tokens according to degrees of rarity.

Scaling the gradient part may include: calculating a first gate tensor on a first gradient part, wherein the first gradient part is configured to push the embedding vectors of the grouped rare tokens away from the feature vectors having the non-rare target tokens when applied to training, among the gradients of the loss function; controlling a degree of the pushing; reducing a scale of the first gradient part according to a reference value; and reducing the degree of the pushing.

Scaling the gradient part may include: calculating a second gate tensor on a second gradient part, wherein the second gradient part is configured to push the embedding vectors of the second rare tokens away from feature vectors having the rare target tokens, with a smaller number of occurrences than the non-rare target tokens, when applied to training; controlling a degree of the pushing; keeping a scale of the second gradient part from dropping below a reference value; and increasing the degree of the pushing relative to an original degree before the scale of the second gradient part is reduced.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram illustrating constituent components of a gradient control device of a language model according to an embodiment;

FIG. 2 illustrates storing a number of appearances for each token in a memory using the gradient control device of FIG. 1;

FIG. 3 is a flowchart illustrating a gradient control method of a language model according to an embodiment;

FIG. 4 illustrates an example computing system.

### DETAILED DESCRIPTION

Like reference numerals throughout the specification denote like elements. Also, this specification does not describe all the elements according to example embodiments of the disclosure, and descriptions well-known in the art to which the disclosure pertains or overlapped portions are omitted.

It should be further understood that the terms “include”, “comprise” and/or “have” and variations thereof, when used in this specification, specify the presence of stated features, integers, steps, operations, elements, and/or components, but do not preclude the presence or addition of one or more other features, integers, steps, operations, elements, components, and/or groups thereof.

The term “and/or” includes any and all combinations of one or more of the associated listed items.

It is to be understood that the singular forms are intended to include the plural forms as well, unless the context clearly dictates otherwise.

The terms such as “part”, “module”, “member”, and “block” may be embodied as hardware or software. In some forms of the present disclosure, a plurality of “unit”, “module”, “member”, and “block” may be implemented as a single component or a single “unit”, “module”, “member”, and “block” may include a plurality of components.

Reference numerals used for method steps are just used for convenience of explanation, but not to limit an order of the steps. Thus, unless the context clearly dictates otherwise, the written order may be practiced otherwise.

Hereinafter, one or more example embodiments of the disclosure will be described in detail with reference to the accompanying drawings.

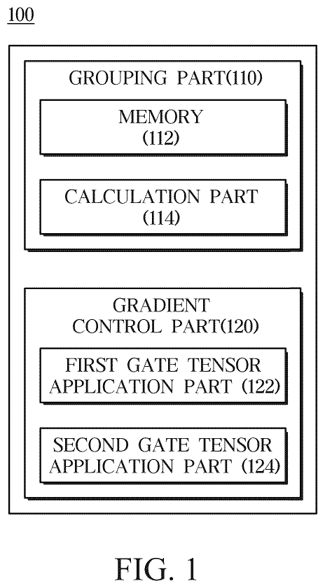

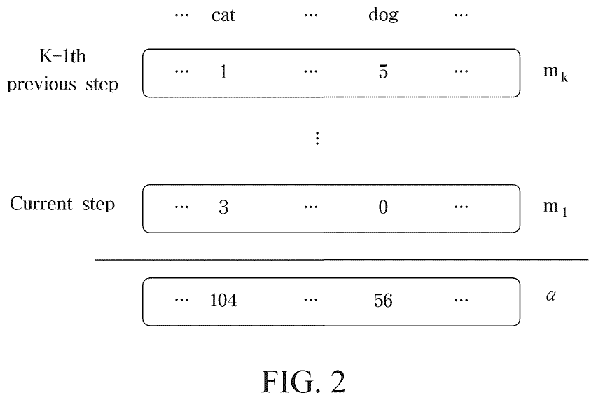

FIG. 1 is a block diagram illustrating constituent components of a gradient control device of a language model. FIG. 2 illustrates storing a number of appearances (e.g., occurrences) for each token in a memory using the gradient control device of FIG. 1. Some or all of the constituent parts as shown in FIG. 1 and other drawings may be implemented with software, hardware (e.g., a computing system 1000 of FIG. 7), or a combination of both.

Referring to FIG. 1 and FIG. 2, a gradient control device 100 of a language model includes a grouping part 110 and a gradient control part 120. Here, the grouping part 110 calculates the number of appearances of each token in batch data at each training step from a current training step to a previous training step, and groups rare tokens based on the calculated number of appearances of each token. The gradient control part 120 calculates a gate tensor on embedding vectors of the grouped rare tokens, and scales a gradient part serving to push the embedding vectors of the grouped rare tokens away from feature vectors having relatively non-rare or rare target tokens, among gradients of a loss function for the embedding vectors of the grouped rare tokens in a training step.

The grouping part 110 may include a memory 112 storing the number of appearances of each token.

The grouping part 110 may include a calculation part 114 calculating an average number of appearances for each token by summing all the number of appearances of each token stored in each memory 112. In this instance, the grouping part 110 may perform rare token grouping by discriminating tokens having an average number of appearances less than a set value as the rare tokens.

The grouping part 110 may group rare tokens and very rare tokens according to a degree of rarity.

The gradient control part 120 may include a first gate tensor application part 122 to calculate a first gate tensor on a first gradient part serving to push embedding vectors of the rare tokens away from feature vectors having the non-rare target tokens when applied to the training among the gradients of the loss function in order to control a degree of pushing.

In this instance, the first gate tensor application part 122 may reduce a scale of the first gradient part according to a reference value by calculating the first gate tensor on the first gradient part, and reduce the degree of pushing the embedding vectors of the rare tokens away from the feature vectors having the non-rare target tokens.

The gradient control part 120 may include a second gate tensor application part 124 to calculate a second gate tensor on a second gradient part serving to push embedding vectors of the very rare tokens away from feature vectors having rare target tokens with a relatively small number of appearances when applied to the training in order to control the degree of pushing.

In this instance, the second gate tensor application part 124 may control a scale of the second gradient part by keeping the scale from dropping below a reference value by calculating the second gate tensor on the second gradient part, and may cause the degree of pushing the embedding vectors of the very rare tokens away from the feature vector having the rare target tokens with the relatively small number of appearances (e.g., occurrences) to be greater than an original degree before a scale of the second gradient part is reduced.

Hereinafter, constituent components and operation processes of the gradient control device 100 of a language model are described in detail.

With T context feature vectors, hᵢ(i ∈[1, T]) from training samples, a gradient of a negative log likelihood (NLL) loss function (hereinafter, simply referred to as a ‘gradient’) for a rare token embedding vector wᵣ may be expressed as Equation 1 below.

$${∇}_{{w}_{r}} {L}_{NLL} = {\underbrace{{\sum }_{{y}_{i} = {υ}_{r}} ( {p}_{r \vert i} - 1 ) {h}_{i}}}_{( a )} + {\underbrace{{\sum }_{{y}_{j} ∉ {V}_{r}} {p}_{r \vert j} {h}_{j}}}_{( b )} + {\underbrace{{\sum }_{{y}_{k} ∈ {V}_{r}} {p}_{r \vert k} {h}_{k}}}_{( c )} \qquad [ Equation 1 ]$$

In Equation 1, yᵢ denotes a target token for feature vector hᵢ, and Vᵣ denotes a rare token vocabulary group. P_{r|i} denotes a conditional probability of a token Uᵣ or given hᵢ, which is calculated as [softmax (hᵢw^{T})]ᵣ. The gradient for wᵣ may be divided into a gradient part (a), a gradient part (b) and a gradient part (c).

The gradient part (a) serves to pull wᵣ close to the feature vectors hᵢ whose target tokens are Uᵣ in a contextual embedding space.

The gradient part (b) serves to push wᵣ away from feature vectors hⱼ in the contextual embedding space. In this instance, target tokens of the feature vectors hⱼ are non-rare tokens that are relatively not rare based on a reference value.

The gradient part (c) serves to push wᵣ away from feature vectors hₖ in the contextual embedding space. In this instance, target tokens of the feature vectors hₖ are rare tokens that are relatively rare based on the reference value.

Experimental results suggest that the gradient part (b) is a cause of degeneration where learned token embedding vectors of language model are degenerated to be anisotropic with a narrow cone-shape. Degeneration may refer to an increase in overall similarity between embedding vectors of tokens.

To overcome the degeneration, a scale of the gradient part (b) used in embedding training is required to be controlled (also known as ‘scaling’).

To this end, the grouping part 110 discriminates and groups rare tokens. In this instance, the grouping part 110 calculates the number of appearances (e.g., occurrences) of each token in batch data at each training step from a current training step to a set previous training step, and rare tokens may be discriminated and grouped based on the calculated number of appearances of each token.

As shown in FIG. 2, at each training step from a current training step to a preset previous K-1^{th} training step, the number of appearances of each token in batch data may be calculated, and stored in each memory 112 m₁ . . . , m_{K} Each memory 112 may be provided at each training step.

To consider token appearances in recent batch data, a token counter memory 112 may be used to remember the number of appearances of each token during previous training steps.

For K memories [m₁, . . . , mₓ] mₜ ∈ [symbol] ^{N} represents the number of appearances of each token of N-size vocabulary at the t^{th} previous training step. The memory 112 may be set as zero vector at an initial stage.

The calculation part 114 may calculate a sum of the number of appearances of each token through a sum a=Σₜ₌₁^{k}mₜ of the number of appearances of each token stored in each memory.

Here, a may be defined as a token appearance vector. Whether a token i is in the rare token group Vᵣ may be determined based on a, as shown in Equation 2 below.

$$\frac{{a}_{i}}{K} < α {υ}_{i} ∈ {V}_{r} \qquad [ Equation 2 ]$$

$$\frac{{a}_{i}}{K} \geq α {υ}_{i} ∉ {V}_{r}$$

In Equation 2, aᵢ is an i^{th} component of a, and a is a hyper-parameter controlling a proportion of rare tokens in entire vocabulary, and may be used as a threshold to discriminate rare tokens. K may be set to the number of iteration steps during one epoch of the training stage.

At each iterative training step, rare tokens are discriminated and grouped based on the number of appearances of each token calculated at each training step for the previous K-1^{th} training step from the current training step. Accordingly, rare tokens that are grouped may vary.

Here, the calculation unit 114 may divide aᵢ by K to calculate an average number of appearances for each token. Tokens with an average number of appearances smaller than (x are discriminated (or classified) as rare tokens and included in a rare token group.

After dynamically grouping the rare tokens by the grouping part 110 as described above, the gradient control part 120 may calculate a gate tensor on embedding vectors of the grouped rare tokens, and scale a gradient part serving to push the embedding vectors of the grouped rare tokens away from feature vectors having target tokens which are relatively not rare or rare, among gradients of the loss function for the embedding vectors of the rare tokens in a training step.

That is, the gradient control part 120 may perform scaling on the gradient part that negatively affects training in order to overcome token's embedding vector degeneration.

To control the gradient of the rare token embedding vectors, a gradient gating method for a parameter x is used. x may be defined as an embedding matrix composed of embedding vectors of every token.

\tilde{X} may be defined as a tensor whose value is the same as x, which is currently detached from a training graph, which implies that \tilde{X} is a constant and a gradient about \tilde{X} is non-existent. \tilde{X} may be easily calculated from x by a detach function of Pytorch.

The gradient for x may be gated using \tilde{X}, which may be expressed as in Equation 3 below.

$${x}_{gated} = g ⊙ x + ( 1 - g ) ⊙ \tilde{x} \qquad [ Equation 3 ]$$

$${∇}_{x} f ( {x}_{gated} ) = g ⊙ {∇}_{x} f ( x )$$

In Equation 3, ⊙ denotes a Hadamard product, X_{gated} is a new parameter and a value of X_{gated} is the same as x. Also, g ∈[0,1] is a gate tensor (also referred to as a gate vector). When the X_{gated} is fed as input to a function ƒ(·), the gradient for x is gated by a gate tensor g. The function ƒ(·) corresponds to the loss function L_{NLL}. The gate tensor is operated only on the rare token's embedding vector among the embedding vectors of an embedding matrix.

The gate tensor is applied to each embedding vector of tokens having an index corresponding to each dimension index by Hadamard product ⊙ operation in a forward operation. In addition, a gradient for embedding vectors of the loss function is scaled by a value multiplied by the gate tensor, in a backward operation due to the Hadamard product operation.

To address the part (b) of Equation 1 above, given a context feature vector hᵢ of an i^{th} position, a gate tensor g₁ ∈ [symbol] ^{N} may be represented as Equation 4 below.

$${g}_{1 k} = \{ \begin{matrix}{a}_{k} / K & if {υ}_{k} ∈ {V}_{r} , {υ}_{k} \neq {y}_{i} \\ 1 & else ,\end{matrix} \qquad [ Equation 4 ]$$

In Equation 4, g₁ₖ is a k^{th} component of g₁. g₁ controls a degree to which the rare token's embedding vectors move away from feature vectors having non-rare target tokens. Each component of g₁ may be calculated based on a rarity of aₖ. aₖ represents the number of appearances of a token assigned to a k^{th} index.

When the token having the k^{th} index is a rare token, a gradient may be scaled by dividing aₖ: by K used to group the rare tokens and applying a relative appearance frequency.

In this instance, in ‘if’ part of Equation 4, uₖ is required to belong to the rare token group Vᵣ and must not be a correct answer token yᵢ. Also, the token of the k^{th} position of the gate tensor refers to that a token with the k^{th} index will be handled. In ‘else’ part of Equation 4, a value of 1 refers to that a gradient is transmitted as it is without scaling, when the token is not a rare token.

Meanwhile, the part (c) of Equation 1 above pushes the rare token embedding vectors away from the feature vectors whose target tokens are rare tokens. The part (c) of Equation 1 may induce degeneration when rare tokens degenerate other rare tokens, even though the part (c) of Equation 1 does not appear to be a cause of the degeneration.

To address the above, depending on the degree of rarity, a rarity level may be classified into multiple levels. For example, levels may be classified into a rare level and a very rare level based on an average number of appearances of entire rare tokens. Accordingly, the grouping part 110 may group rare tokens and very rare tokens that are rarer than the rare tokens according to the degree of rarity.

Specifically, when the token appearance aₖ is smaller than the average of aᵣ where r∈Vᵣ, corresponding token is a very rare token. aᵣ represents the number of appearances of rare tokens.

For embedding vectors of very rare tokens, the gradient part (c) of Equation 1 above serves to push the embedding vectors of very rare tokens away from feature vectors whose targets are less rare tokens that are relatively frequent compared to the embedding vectors of very rare tokens, causing the gradient part (c) to act like the gradient part (b) and leading to the degeneration.

Accordingly, the gradient part (c) of Equation 1 for the embedding vectors of very rare tokens is required to be addressed.

To address the gradient part (c) of Equation 1 for the embedding vectors of very rare tokens, another gate tensor g₂ ∈ [symbol] ^{N} may be used, which may be expressed as in Equation 5 below.

$${g}_{2 k} = \{ \begin{matrix}min ( \frac{{a}_{k}}{{\overline{a}}_{r}} , 1 ) & if {υ}_{k} ∈ {V}_{r} , {υ}_{k} \neq {y}_{i} \\ 1 & else ,\end{matrix} \qquad [ Equation 4 ]$$

where g₂ₖ is a k^{th} component of g₂. āᵣ is an average of the number of appearances aᵣ of rare tokens where r∈Vᵣ. When aₖ is smaller than āᵣ, it may be defined as a very rare token. g₂ controls a degree to which very rare token's embedding vectors move away from feature vectors having rare target tokes that are relatively more frequent. Each component of g₂ may be calculated based on the rarity of each very rare token aₖ.

In order to calculate the loss of hᵢ described above, three logits of zᵢ⁰, zᵢ¹ and zᵢ² may be calculated as shown in Equation 6 below.

$${z}_{i}^{0} = {h}_{i} {\tilde{W}}^{T} \qquad [ Equation 6 ]$$

$${z}_{i}^{l} = {g}_{l} ⊙ {\tilde{h}}_{i} {W}^{T} + ( 1 - {g}_{l} ) ⊙ {\tilde{h}}_{i} {\tilde{W}}^{T}$$

In Equation 6, W denotes an embedding matrix made up of embedding vectors of tokens, and l=1, 2. In case of l=1, the above-described gate tensor g₁ (also referred to as a first gate tensor) is applied, and in case of l=2, the above-described gate tensor g₂ (also referred to as a second gate tensor) is applied.

zᵢ⁰ for training a model may be represented as a result of an inner product of feature vector hᵢ that does not require to be gated with all the token embedding vectors, which may be a numerical representation of how semantically close the feature vector hᵢ is to the token's embedding vectors. For a token's embedding vector that is semantically close to the feature vector hᵢ, a token of the corresponding token's embedding vector is more likely to be predicted.

In zᵢ⁰, a gradient is only applied to learning of hᵢ. In the zᵢ¹ and zᵢ² that affect the learning of the token's embedding vectors, a gradient is applied only to learning of W, not to learning of hᵢ.

In zᵢ¹, a gradient is applied to learning of embedding vectors of tokens corresponding to the gradient part (b) described above, and is scaled by the first gate tensor.

In zᵢ², a gradient is applied to learning of embedding vectors of tokens corresponding to the gradient part (c) described above, and is scaled by the second gate tensor.

Next, an NLL loss for Lᵢ of an i^{th} position is calculated by applying Equation 6, which may be expressed as Equation 7 below.

$$[ Equation 7 ]$$

$${L}_{i} = - log {p}_{I ( {y}_{i} ) \vert i}^{0} - ( {y}_{i} ∉ {V}_{r} ) log {p}_{I ( {y}_{i} ) \vert i}^{1} - ( {y}_{i} ∈ {V}_{r} ) log {p}_{I ( {y}_{i} ) \vert i}^{2}$$

Where P_{I(y}_{ᵢ}_{)|i}^{m}=[softmax (zᵢ^{m})]_{I(y}_{ᵢ}₎ with m=0, 1, 2, and [symbol] (·) denotes an Indicator function. An index of a correct answer token yᵢ of the i^{th} position is represented as I (yᵢ), and its conditional probability P may be calculated by a softmax function that uses the logit calculated in Equation 6 as an input value.

Also, a gradient of the loss function for the rare token's embedding vectors wᵣ may be expressed as Equation 8 below.

$${∇}_{{w}_{r}} {L}_{i} = \{ \begin{matrix}( {p}_{r \vert i} - 1 ) {h}_{i} & if {y}_{i} = {υ}_{r} \\ {g}_{1 r} {p}_{r \vert i} {h}_{i} & if {y}_{i} ∉ {V}_{r} \\ {g}_{2 r} {p}_{r \vert i} {h}_{i} & else ,\end{matrix} \qquad [ Equation 8 ]$$

In Equation 8, (P_{r|i}-1) h; corresponds to the gradient part (a) of Equation 1. g₁_{ᵣ}_{P}_{ᵣ}_{|i}hᵢ represents a gradient scaled by applying the first gate tensor to the gradient part (b) of Equation 1 (hereinafter, also referred to as the first gradient part). g₂_{ᵣ}_{P}_{ᵣ}_{|i}hᵢ represents a gradient scaled by applying the second gate tensor to the gradient part (c) of Equation 1 (hereinafter, also referred to as the second gradient part).

That is, the first gate tensor application part 122 calculates the first gate tensor on the first gradient part serving to push the embedding vectors of the rare tokens away from the feature vectors having non-rare target tokens when applied to the training among the gradients of the loss function, in order to control the degree of pushing.

In this instance, the first gate tensor application part 122 may reduce a scale of the first gradient part according to a reference value by calculating the first gate tensor on the first gradient part, and reduce a degree of pushing the embedding vectors of the rare tokens away from the feature vectors having the non-rare target tokens.

Also, the second gate tensor application part 124 calculates the second gate tensor on the second gradient part serving to push embedding vectors of very rare tokens away from feature vectors having rare target tokens with a relatively small number of appearances when applied to the training, in order to control the degree of pushing.

The second gate tensor application part 124 controls a scale of the second gradient part by keeping the scale from dropping below a reference value by calculating the second gate tensor on the second gradient part, and causes a degree of pushing the embedding vectors of the very rare tokens away from the feature vectors having the rare target tokens with the relatively small number of appearances to be greater than an original degree before the scale of the second gradient part is reduced.

As described above, using an adaptive gradient gating (AGG) method that applies the first gate tensor and the second gate tensor to the first gradient part and the second gradient part that interfere learning, respectively, the above-described degeneration may be effectively overcome by reducing a similarity between token embedding vectors.

In addition, the AGG method is optimized for the embedding vectors of rare tokens, which are the main cause of degeneration, and thus over-regulating non-rare token embedding vectors may be prevented.

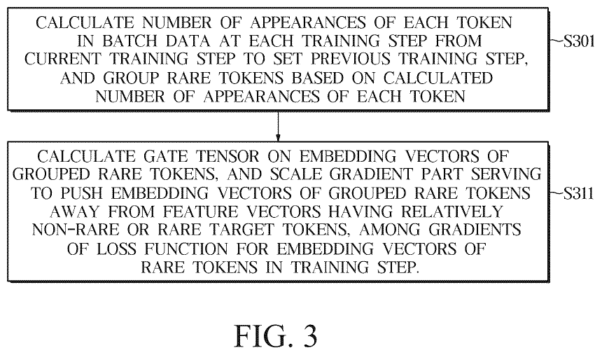

FIG. 3 is a flowchart illustrating a gradient control method of a language model.

Referring to FIG. 3, the number of appearances (e.g., occurrences) of each token in batch data is calculated at each training step from a current training step to a previous training step, and rare tokens are grouped based on the calculated number of appearances of each token (S301).

In operation S301, the calculated number of appearances of each token may be stored in a corresponding memory 112.

Also, in operation S301, an average number of appearances may be calculated for each token by summing all the number of appearances of each token stored in each memory 112, and rare token grouping may be performed by discriminating tokens having an average number of appearances less than a set value as the rare tokens.

In addition, in operation S301, the rare token grouping may be performed by dividing the rare tokens into a plurality of groups and may group rare tokens and very rare tokens according to a degree of rarity.

Next, a gate tensor is calculated on embedding vectors of the grouped rare tokens to scale a gradient part serving to push the embedding vectors of the grouped rare tokens away from feature vectors having relatively non-rare or rare target tokens, among gradients of a loss function for the embedding vectors of the rare tokens in the training step (S311).

In operation S311, a first gate tensor is calculated on a first gradient part serving to push the embedding vectors of the rare tokens away from feature vectors having non-rare target tokens when applied to the training among the gradients of the loss function, to reduce a scale of the first gradient part according to a reference value and reduce a degree of pushing the embedding vectors of the rare tokens away from the feature vectors having the non-rare target tokens.

Through the above, a similarity between the rare token embedding vectors pushed together in the same direction and converged may be reduced, thereby preventing the degeneration.

Also, in operation S311, a second gate tensor may be calculated on a second gradient part serving to push embedding vectors of the very rare tokens away from feature vectors having rare target tokens with a relatively small number of appearances when applied to the training.

In addition, in operation S311, by controlling a scale of the second gradient part not to decrease below a reference value, a degree of pushing the embedding vectors of the very rare tokens away from the feature vectors having the rare target tokens with the relatively small number of appearances may be greater than an original degree before a scale of the second gradient part is reduced.

That is, by ensuring that the embedding vectors of very rare tokens are not pushed from the feature vectors having the rare target tokens less than the original degree, the degeneration may be overcome.

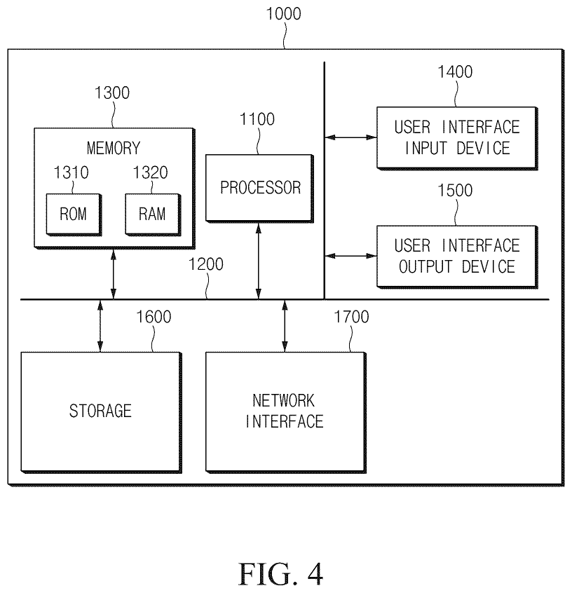

FIG. 4 illustrates an example computing system. One or more example embodiments described herein may be implemented with software, hardware, or a combination of both. The hardware may include a computing system 1000 as shown in FIG. 4. The computing system 1000 include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Thus, the operations of the method or the algorithm described in connection with the example embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The example storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

As is apparent from the above, according to the embodiments of the disclosure, the gradient control device and the gradient control method of a language model can prevent an overall increase in similarity between embedding vectors of tokens, enabling a language model to learn a semantic relationship between tokens and generate high quality text.

Although embodiments have been described for illustrative purposes, those skilled in the art will appreciate that various modifications, additions and substitutions are possible, without departing from the scope and spirit of the disclosure. Therefore, embodiments have not been described for limiting purposes.

What is claimed is:

1. A gradient control device of a language model, the gradient control device comprising:
one or more processors; and
memory storing instructions that, when executed by the one or more processors, cause the gradient control device to:
calculate a number of occurrences of each token, of a plurality of tokens, in batch data at each training step of a plurality of training steps ranging from a current training step to a set previous training step;
group rare tokens based on a comparison of the calculated number of occurrences of each token, of the plurality of tokens, with a threshold value;
calculate a gate tensor on embedding vectors of the grouped rare tokens; and
scale a gradient part that pushes the embedding vectors of the grouped rare tokens away from feature vectors having relatively non-rare and feature vectors having relatively rare target tokens, among gradients of a loss function for the embedding vectors of the grouped rare tokens in a training step.

2. The gradient control device of claim 1, wherein the memory further store the calculated number of occurrences of each token of the plurality of tokens.

3. The gradient control device of claim 2, wherein the instructions, when executed by the one or more processors, further cause the gradient control device to:
calculate an average number of occurrences of each token of the plurality of tokens by summing all numbers, stored in the memory, of occurrences of each token of the plurality of tokens, and
wherein the instructions, when executed by the one or more processors, cause the gradient control device to group the rare tokens by determining one or more tokens, having an average number of occurrences less than the threshold value, to be the rare tokens.

4. The gradient control device of claim 1, wherein the instructions, when executed by the one or more processors, further cause the gradient control device to group the rare tokens by grouping first rare tokens and second rare tokens according to degrees of rarity.

5. The gradient control device of claim 4, wherein the instructions, when executed by the one or more processors, further cause the gradient control device to:
calculate, using a first gate tensor application, a first gate tensor on a first gradient part, wherein the first gradient part is configured to push the embedding vectors of the grouped rare tokens away from the feature vectors having the non-rare target tokens when applied to training, among the gradients of the loss function; and
control a degree of the pushing.

6. The gradient control device of claim 5, wherein the instructions, when executed by the one or more processors, further cause the gradient control device to:
reduce, using the first gate tensor application, a scale of the first gradient part according to a reference value by calculating the first gate tensor on the first gradient part; and
reduce the degree of the pushing.

7. The gradient control device of claim 4, wherein the instructions, when executed by the one or more processors, further cause the gradient control device to:
calculate, using a second gate tensor application, a second gate tensor on a second gradient part, wherein the second gradient part is configured to push the embedding vectors of the second rare tokens away from feature vectors having the rare target tokens, with a smaller number of occurrences than the non-rare target tokens, when applied to training; and
control a degree of the pushing.

8. The gradient control device of claim 7, wherein the second gate tensor application is configured to keep a scale of the second gradient part from dropping below a reference value by calculating the second gate tensor on the second gradient part, and configured to increase the degree of the pushing relative to an original degree before the scale of the second gradient part is reduced.

9. A method of controlling a gradient of a language model, the method comprising:
calculating a number of occurrences of each token, of a plurality of tokens, in batch data at each training step of a plurality of training steps ranging from a current training step to a set previous training step;
grouping rare tokens based on a comparison of the calculated number of occurrences of each token, of the plurality of tokens, with a threshold value;
calculating a gate tensor on embedding vectors of the grouped rare tokens; and
scaling a gradient part that pushes the embedding vectors of the grouped rare tokens away from feature vectors having relatively non-rare and feature vectors having relatively rare target tokens, among gradients of a loss function for the embedding vectors of the grouped rare tokens in a training step.

10. The method of claim 9, wherein the grouping of the rare tokens comprises storing, in a memory, the calculated number of occurrences of each token of the plurality of tokens.

11. The method of claim 10, wherein the grouping of the rare tokens comprises:
calculating an average number of occurrences of each token of the plurality of tokens by summing all numbers, stored in the memory, of occurrences of each token of the plurality of tokens, and
determining one or more tokens, having an average number of occurrences less than the threshold value, to be the rare tokens.

12. The method of claim 9, wherein the grouping of the rare tokens comprises grouping the rare tokens into a plurality of groups, and grouping first rare tokens and second rare tokens according to degrees of rarity.

13. The method of claim 12, wherein the scaling of the gradient part comprises:
calculating a first gate tensor on a first gradient part, wherein the first gradient part is configured to push the embedding vectors of the grouped rare tokens away from the feature vectors having the non-rare target tokens when applied to training, among the gradients of the loss function;
controlling a degree of the pushing;
reducing a scale of the first gradient part according to a reference value; and
reducing the degree of the pushing.

14. The method of claim 12, wherein the scaling of the gradient part comprises:
calculating a second gate tensor on a second gradient part, wherein the second gradient part is configured to push the embedding vectors of the second rare tokens away from feature vectors having the rare target tokens, with a smaller number of occurrences than the non-rare target tokens, when applied to training;
controlling a degree of the pushing;
keeping a scale of the second gradient part from dropping below a reference value; and
increasing the degree of the pushing relative to an original degree before the scale of the second gradient part is reduced.
